(19) United States
(12) Patent Application Publication
(10) Pub. No.: US 2005/0071154 A1
(43) Pub. Date: Mar. 31, 2005

(54) Method and apparatus for estimating noise in speech signals

(76) Inventor: Walter Etter, Wayside, NJ (US)

Correspondence Address: Docket Administrator (Room 3J-219);Lucent Technologies Inc., 101 Crawfords Corner Road, Holmdel, NJ, 07733-3030, US

(21) Appl. No.: 10/674,450

(22) Filed: Sep. 30, 2003

(51) Int. Cl. G10L 19/12

(52) U.S. Cl. 704/223

(57) ABSTRACT

Noise in a speech signal is estimated using only the excitation value of the speech signal. More specifically, an encoded speech signal (i.e., bit stream) is partially decoded to obtain an excitation parameter. The excitation parameter is used as input to estimate the noise level of the speech signal. In one example, the excitation parameter is the fixed codebook gain of the speech signal. The fixed codebook gain is multiplied by a scaling factor (e.g., constant value) and then used as input for noise estimation. The scaling factor can also be variable and computed as a function of adaptive codebook gain that is also obtained from the partially decoded bit stream.

### TECHNICAL FIELD

The present invention relates generally to processing speech signals and, more specifically, to estimating noise in speech signals.

### BACKGROUND OF THE INVENTION

Cellular phones and networks employ speech codecs to reduce the data rate in order to make efficient use of the bandwidth resources in the radio interface. In a mobile-to-mobile call, the PCM (pulse code modulation) speech signal is first encoded into a lower-rate bit stream by the speech codec of mobile A, transmitted over the network, and then decoded back into a PCM signal in the speech codec of mobile B. Speech codecs are also used in Internet-based transmission in conjunction with IP (Internet Protocol) phones. As in cellular phones, the reduced data rate due to speech codecs allows for more throughput, that is, more telephone conversation, for a given transmission medium.

In recent years, several measures have been taken to improve the voice quality of wireless communication. One improvement stems from enhancing speech codecs. For example, in the well known European cellular phone standard GSM, the Full Rate (FR) codec was supplemented with the Enhanced Full Rate (EFR) codec, a codec with better voice quality. Another improvement resulted from introducing network equipment that supports Tandem Free Operation (TFO) or Transcoder Free Operation (TrFO). These techniques are intended to avoid traditional double encoding/decoding in a mobile-to-mobile call. Without TFO or TrFO, the network first decodes the bit stream from a mobile station A into a regular PCM signal and then encodes it again before transmission over the air link to a mobile station B.

Signal processing to enhance voice communication can be performed in the terminal, e.g., cell phone, land phone, and so on, or in the network, e.g., BTS (Base Transceiver Station), BSC (Base Station Controller), MSC (Mobile Switching Center). In conventional methods, voice quality enhancements such as acoustic echo control, noise compensation, noise reduction, and automatic gain control, is solely performed on PCM speech signals. When such signal processing is performed in the network, tandem free operation or transcoder free operation is no longer possible. As a result of double speech encoding/decoding, speech quality is always degraded, making network-located signal processing and signal enhancement less appealing. Yet, it would be desirable to perform signal enhancement in the network for economic reasons. For example, when signal enhancement is implemented in the mobile station, the additional computational load drains the battery more quickly, thus requiring frequent recharging. When implemented in the network, such drawbacks do not exist. In addition, computational resources can be shared in the network among users, thus making even complex algorithms economical.

As is well known, various signal processing functions require an estimation of noise in the speech signal. For example, the aforementioned voice quality enhancement techniques of acoustic echo control, noise compensation and noise reduction each employ some form of noise estimation. In noise compensation, for example, near-end noise is estimated to adjust the far-end speech level. A noise estimator is also commonly used in a voice activity detector (VAD). Other applications will be apparent to one skilled in the art. Conventional techniques for estimating noise level in a speech signal are based on processing the PCM speech signal. As such, these techniques are known to be computationally complex and inefficient because the transmitted bit stream (e.g., an encoded speech signal) must be fully decoded to obtain the PCM signal so that the noise level can then be estimated from the PCM signal.

### SUMMARY OF THE INVENTION

Computational complexity is reduced and greater channel densities can be realized according to the principles of the invention by estimating noise in a speech signal using only the excitation value of the speech signal. More specifically, the encoded speech signal (i.e., bit stream) is partially decoded to obtain an excitation parameter corresponding to the speech signal and the excitation parameter is then used as input to estimate the noise level of the speech signal.

In one illustrative embodiment, a bit stream is partially decoded to unpack the fixed codebook gain parameter of the speech signal. The fixed codebook gain parameter is then multiplied by a scaling factor (e.g., constant value) and the scaled fixed codebook gain parameter is then used as input to a noise estimator. In another illustrative embodiment, the bit stream is partially decoded to extract both the fixed codebook gain parameter and the adaptive codebook gain parameter. The fixed codebook gain parameter is then multiplied by a scaling factor that is computed as a function of the adaptive codebook gain parameter.

Because the noise level estimate is derived directly from the excitation value of the speech signal, e.g., fixed codebook gain, rather than from the PCM signal, a significant reduction in computational complexity can be realized as compared to PCM signal-based noise estimation in the prior art. In particular, only partial decoding is required to unpack the fixed codebook gain as opposed to fully decoding and reconstructing a fully synthesized PCM signal as in the prior art arrangements. Because of the reduced computational complexity and power requirements, greater channel density and lower costs can be realized using the noise estimation technique according to the principles of the invention.

### BRIEF DESCRIPTION OF THE DRAWINGS

A more complete understanding of the present invention may be obtained from consideration of the following detailed description of the invention in conjunction with the drawing, with like elements referenced with like reference numerals, in which:

FIG. 1 is a block diagram illustrating a conventional arrangement for estimating noise in a speech signal;

FIG. 2 shows a simplified block diagram of a conventional adaptive multi-rate (AMR) decoder;

FIG. 3 is a block diagram showing one illustrative embodiment of the invention;

FIG. 4 is a block diagram showing another illustrative embodiment of the invention; and

FIG. 5 is plot illustrating exemplary results for performing noise estimation on a signal according to the principles of the invention.

### DETAILED DESCRIPTION

Although the illustrative embodiments of the invention are applicable to the well-known GSM (Global System for Mobile Communications) cellular system standard using Adaptive Multi-Rate (AMR) speech coders, and will be described in this exemplary context, those skilled in the art will understand from the teachings herein that the principles of the invention may also be employed in other applications that require noise estimation. For example, the invention can be used in other standards-based cellular communication systems, Voice-over-Internet (VoIP) applications, and so on.

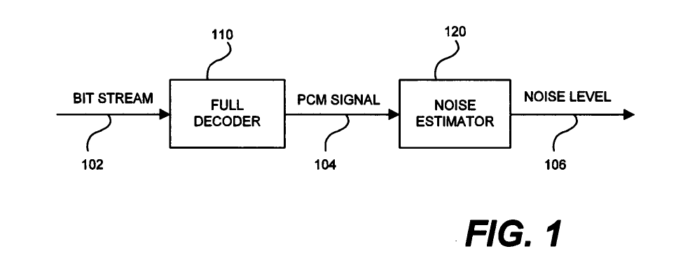

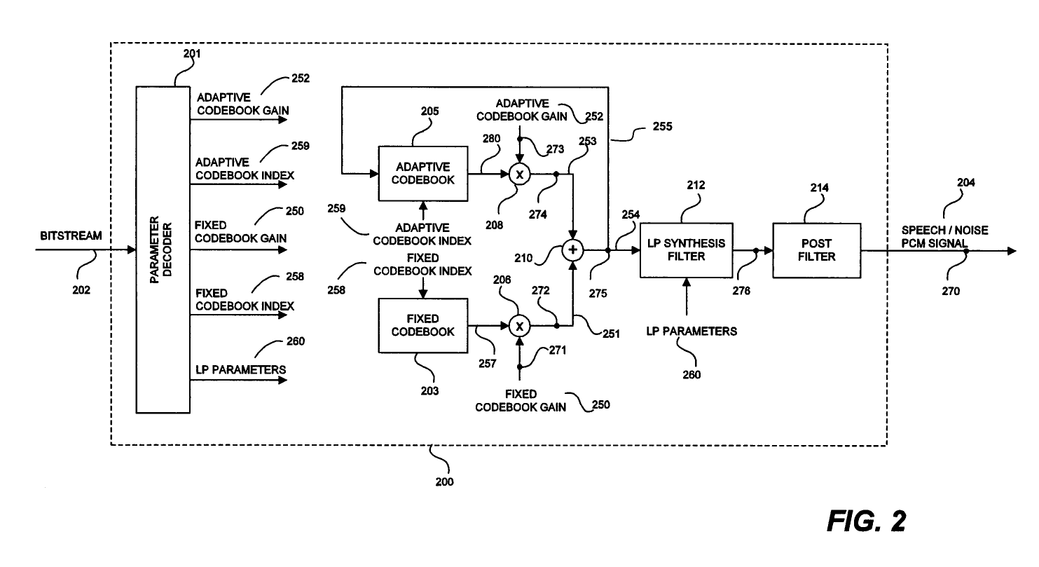

A brief description of a conventional approach for estimating noise in a GSM-based network employing AMR speech coders will now be provided with reference to FIGS. 1 and 2 to provide a foundation for understanding the principles of the invention. More specifically, FIG. 1 illustrates a conventional approach for estimating the noise level from a speech signal. In this example, bit stream 102 represents an encoded speech signal, which is generated in a conventional manner, e.g., speech codec in a mobile (or Internet Protocol) phone encodes a pulse code modulated (PCM) signal for transmission through the network. As shown, bit stream 102 is fully decoded by decoder 110 to produce the PCM signal 104. A conventional noise estimator 120 is subsequently applied to estimate the noise level 106 of the fully decoded PCM signal 104. Estimating the noise level of a speech signal in this manner is well known to those skilled in the art. For example, one approach for estimating noise parameters is disclosed in U.S. Pat. No. 4,185,168 issued to D. Graupe et al. on Jan. 22, 1980 and entitled “Method and Means for Adaptively Filtering Near-Stationary Noise From an Information Bearing Signal”, which is incorporated by reference herein. This patent describes a noise estimator that detects the minima of successively smoothed input magnitude values. The smallest minimum out of a predefined number of minima is used as an estimate for the spectral magnitude of the noise. Another example of a noise estimator is described in a dissertation entitled, “Contributions to Noise Suppression in Monophonic Speech Signals,” by Walter Etter, Ph.D. Thesis, ETH Zurich, 1993, available from the Swiss Federal Institute of Technology, which is incorporated by reference herein. This estimator, referred to as the “Two Time Parameter” (TTP) noise estimator, provides control over the attack time of the noise estimator via two time parameters. Further improvements in noise estimation are described in U.S. patent application Ser. No. 09/107,919, filed Jun. 30, 1998 by W. Etter, entitled “Estimating the Noise Components of a Signal”, which is incorporated by reference herein. Other examples will be apparent to those skilled in the art.

FIG. 2 shows a simplified block diagram of an exemplary decoder arrangement 200, which could be used, for example, to perform the decoding functions of decoder 110 in FIG. 1. In this exemplary arrangement, decoder 200 is an Adaptive Multi-Rate (AMR) decoder, which is well known in art. See, e.g., ETSI 3GPP TS 26.090: “AMR Speech Codec-Transcoding functions”, which is incorporated by reference herein.

Briefly, an AMR speech codec (i.e., shorthand for “compression/decompression”) is a multi-rate speech coder that is specified for use in 3G wireless applications. Generally speaking, a codec can be DSP software that compresses digitized speech to reduce transmission channel or storage capacity requirements, and then decompresses received samples to reconstruct the original speech signal with some loss in signal quality. The AMR speech codec can handle bit rates between 4.75 and 12.2 Kbps (specifically, 12.2, 10.2, 7.95, 7.40, 6.70, 5.90, 5.15 and 4.75 Kbps) and uses the principle of Algebraic Code Excited Linear Prediction (ACELP) for all specified bit rates. The codec works on a frame of 160 speech samples (20 msec). A variable rate encoding technique is used to change the rate at which speech data is sent in accordance with the interference level (e.g., distance from the base station) or available air-channel resources. While it is specifically designed for 3G cellular services, it can also be used in other applications.

As shown in FIG. 2, decoder 200 includes parameter decoder 201, which receives and decodes incoming bit stream 202 to reproduce the linear prediction (LP) parameters and the excitation parameters such as adaptive codebook gain, adaptive codebook index (also referred to as pitch lag), fixed codebook gain, and fixed codebook index.

As is well known, the most prevailing models used in speech codecs (also referred to as speech coders) are based on linear prediction (LP). In this model, the vocal tract is estimated in the speech encoder using linear prediction (LP) on a frame-by-frame basis. The speech frame to be encoded is then filtered with the vocal tract inverse filter to provide the excitation. The excitation may consist of two parts, the glottal pulse or pitch signal (voiced phonemes) and a noise-like signal (unvoiced phonemes). In other words, the task of the speech encoder is to extract the LP parameters and the excitation parameters. By transmitting only these parameters, the data rate is reduced significantly. For example, instead of transmitting a 64 kbit/s speech signal (8-bit mu-law speech signal sampled at 8 kHz), the data rate is reduced to about 5 to 12 kbit/s for current speech codecs.

To better understand bit stream processing in the context of the current example of the AMR codec, consider the exemplary bit allocation in the 12.2 kbit/s mode shown in Table 1. The speech signal, which has been sampled at a rate of 8 kHz, is segmented by the AMR codec into 20 ms frames consisting of 160 PCM samples. For each frame, the encoder determines 244 bits shown in Table 1, which are transmitted to the receiver. Referring back to FIG. 2, the encoded speech signal is represented by bit stream 202.

TABLE 1
AMR encoder output bit stream for a frame of 20 ms (12.2 kbit/s mode).

| Bits | |
|---|---|
| (MSB-LSB) | Description |
| s1-s7 | index of 1st LSF submatrix |
| s8-s15 | index of 2nd LSF submatrix |
| s16-s23 | index of 3rd LSF submatrix |
| s24 | sign of 3rd LSF submatrix |
| s25-s32 | index of 4th LSF submatrix |
| s33-s38 | index of 5th LSF submatrix |
| Subframe 1 | |
| s39-s47 | adaptive codebook index |
| s48-s51 | adaptive codebook gain |
| s52 | sign information for 1st and 6^{th} pulses |
| s53-s55 | position of 1st pulse |
| s56 | sign information for 2nd and 7th pulses |
| s57-s59 | position of 2nd pulse |
| s60 | sign information for 3rd and 8th pulses |
| s61-s63 | position of 3rd pulse |
| s64 | sign information for 4th and 9th pulses |
| s65-s67 | position of 4th pulse |
| s68 | sign information for 5th and 10th pulses |
| s69-s71 | position of 5th pulse |
| s72-s74 | position of 6th pulse |
| s75-s77 | position of 7th pulse |
| s78-s80 | position of 8th pulse |
| s81-s83 | position of 9th pulse |
| s84-s86 | position of 10th pulse |
| s87-s91 | fixed codebook gain |
| Subframe 2 | |
| s92-s97 | adaptive codebook index (relative) |
| s98-s141 | same description as s48-s91 |
| Subframe 3 | |
| s142-s194 | same description as s39-s91 |
| Subframe 4 | |
| s195-s244 | same description as s92-s141 |

As shown in Table 1, a frame is further divided into four subframes. The parameters in Table 1 consist of the line spectral frequencies (LSF) (also referred to as line spectral pairs (LSPs)), which are allocated to bits s1-s38. These parameters are determined once per frame only, while the remaining parameters are determined for each subframe. The LSF parameters are a particular representation of the LP parameters. The remaining bits s39-s244 shown in Table 1 determine the excitation. They can be divided into fixed codebook (or fixed codebook excitation) and adaptive codebook (or adaptive codebook excitation) parameters. The fixed codebook contains the noise-like component, while the adaptive codebook contains the pitch information.

Referring again to FIG. 2, the main task of parameter decoder 201 is to unpack the bits in bit stream 202 and represent the parameters as 16-bit numbers, for example, for subsequent use in the signal synthesis section of decoder 200, which will be described below. In the case of the LP parameters, parameter decoder 201 also performs interpolation of the LSF (LSP) parameters and subsequent conversion of the LSP parameters to the LP parameters.

The other components of decoder 200 shown in FIG. 2 (other than parameter decoder 201) are typically referred to as the signal synthesis section. Responsive to the decoded parameters generated by parameter decoder 201, the main task of the components in the signal synthesis section is to generate the final PCM signal 204 after filtering the excitation 254 using LP synthesis filter 212 and reducing quantization noise using post filter 214.

As is well known, excitation 254 is generated from the fixed codebook excitation component 251 and the adaptive codebook excitation component 253. More specifically, the fixed codebook excitation component 251 is generated as follows. In a conventional manner, fixed codebook 203 (e.g., a lookup table) provides codebook vector 257 based on the fixed codebook index that is unpacked by parameter decoder 201. Codebook vector 257 is then multiplied using multiplier 206 by the fixed codebook gain 250 (also supplied by parameter decoder 201) to generate fixed codebook excitation component 251.

The adaptive codebook component 253 is generated via a feedback loop 255, which is explained here in a simplified manner. At initialization or start-up of the decoder, the buffer of the adaptive codebook 205 is set to zero. Therefore, signal 280 becomes zero and, likewise, adaptive codebook component 253 becomes zero. In other words, the output of summer 210 is only determined by the fixed codebook excitation component 251. The fixed codebook excitation component, now in 254, is then used as input to the adaptive codebook 205 via feedback loop 255. The function of the adaptive codebook 205 is twofold. First, it retrieves the pitch delay from a look-up table using the adaptive codebook index 259. The input 254 to the adaptive codebook 205 is then delayed in the adaptive codebook 205 by this pitch delay. For the AMR codec example, this delay can be a fractional number, that is, the excitation samples 254 need to be interpolated in between the 8 kHz sampling-interval to achieve a fractional delay. The fractionally-delayed excitation samples 280 are then multiplied (via multiplier 208) by the adaptive codebook gain 252, a value in the range between zero and one. If the adaptive codebook gain 252 is close to one, a strong periodicity results in the excitation signal 254, indicative of a voiced phoneme. On the other hand, if the adaptive codebook gain 252 is close to zero, no periodicity results in the excitation 254, indicative of an unvoiced phoneme. After computation of the excitation 254, it is filtered with the LP synthesis filter 212, e.g., an infinite impulse response (IIR) filter, whose filter coefficients are given by the LP parameters 260. The LP synthesis filter adds the vocal tract information back to the signal 276. Post filter 214 produces the final PCM signal 204. Its purpose is to improve speech quality by lowering the perceived quantization noise.

Referring now to FIGS. 1 and 2 in the context of prior art arrangements for noise estimation, a decoder such as decoder 200 shown in FIG. 2 is typically used to fully decode the parameters as set forth above. From the PCM signal that is reconstructed by decoder 200 from the incoming bit stream, noise estimation is then performed. More specifically, the input provided to noise estimator 120 (FIG. 1) in a conventional prior art scheme could be supplied from the output of post filter 214 (FIG. 2), i.e., access point 270, in decoder 200. However, when access point 270 is used as input to a noise estimator, the complete decoding operation is performed, i.e., full decoding is required. As such, this type of noise estimation using input from a full decoding operation is computationally complex.

Accordingly, I have discovered a noise estimation scheme with significantly reduced computational complexity. According to the principles of the invention, the excitation of the encoded speech signal is used as input for the noise estimation process. In this manner, only the excitation parameter needs to be extracted or otherwise derived from the incoming encoded signal and, as a result, a full decoding operation with all the associated computational complexity, such as that previously described for the illustrative AMR decoder 200 in FIG. 2, can be avoided.

The choice of input for a noise estimator will now be described in the context of the exemplary AMR decoder in FIG. 2. More specifically, FIG. 2 shows several potential access points, i.e., to derive input for a noise estimator, labeled as access points 270, 271, 272, 273, 274, 275 and 276. Except for 270, each of these access points represents a location in the signal path (in decoder 200) that eliminates at least some function and/or component in decoder 200 in an effort to simplify the decoding operation and associated computational complexity.

Working backwards in the signal path from final PCM output signal 204, access point 276 (for input to a noise estimator) can be considered, but will not likely result in a significant reduction in complexity since only post filter 214 and its accompanying function is omitted. By contrast, access point 275 would result in a substantial reduction in complexity since synthesis filter 212 is omitted. In particular, the determination of LP parameters 260 in parameter decoder 201 is eliminated, which in itself is a computationally intensive process, e.g., interpolating the LSP parameters for each subframe and subsequently converting the LSP parameters to LP parameters and so on.

While access point 275 represents a location (functionally) that simplifies the decoding process, the sufficiency of using the excitation 254 of input signal 202 (at access point 275) as input to a noise estimator will now be described. In particular, I have discovered that excitation 254 can be effectively used to estimate noise in a speech signal instead of a fully synthesized PCM signal, e.g., reconstructed PCM output signal 204 generated from the synthesis and post filtering functions of decoder 200, filters 212 and 214 respectively.

To better understand the effectiveness of using the excitation 254, consider the properties of noise in a speech signal. Because a noise signal is modeled in the same manner as the speech signal when processed by the speech coder, the noise signal can therefore be considered in view of the speech model. If the excitation of the noise is mainly random in nature, i.e., the fixed codebook excitation 251 is the main component of the excitation 254, then the signal level more or less follows the excitation level proportionally. The factor determining the proportion of excitation level to signal level depends on the spectral flatness, or the spectral skewness. For example, a completely flat noise spectrum (white noise) would result in a proportion factor of one, in which case the level of the noise signal would equal the level of the excitation. On the other hand, if the noise spectrum is skewed, the proportion factor will be less than one. The more the spectrum is skewed, the smaller this proportion factor. Assuming an average skewness of frequently encountered random noise sources, the fixed codebook excitation 251 provides an experimentally validated access point for the noise estimator. A scaling factor, the reciprocal of the proportion factor, can be used to compensate for the average skewness. According to another illustrative embodiment, one can use the fixed codebook gain 250 directly, instead of the fixed codebook excitation 251, to further reduce the computational complexity. For example, using codebook gain 250, which is provided on a 40-sample sub-frame basis, versus using codebook excitation 251, which is provided on a sample basis, will reduce the computational complexity by a factor of 40. It should be noted that, because output 257 of the fixed codebook 203 is normalized, i.e., containing only 0's, 1's and −1's, the signal level is mostly determined by the fixed codebook gain 250.

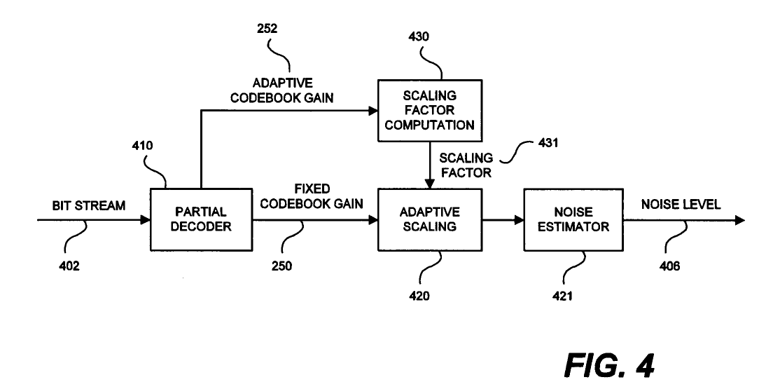

Consider now the case where the noise is mainly deterministic in nature with at least some periodicity in the range of voiced speech (80 Hz to 300 Hz). In this case, the level of the excitation is not only determined by the fixed codebook gain 250, but also by the adaptive codebook gain 252. If only fixed codebook gain 250 is used as an input for the noise estimator, the noise estimator could underestimate the noise level. Consequently, knowledge of the adaptive codebook gain 252 will allow for adjustment of the scaling factor. In other words, the scaling factor can be adapted to the adaptive codebook gain 252, as will be described below with reference to the embodiment shown in FIG. 4.

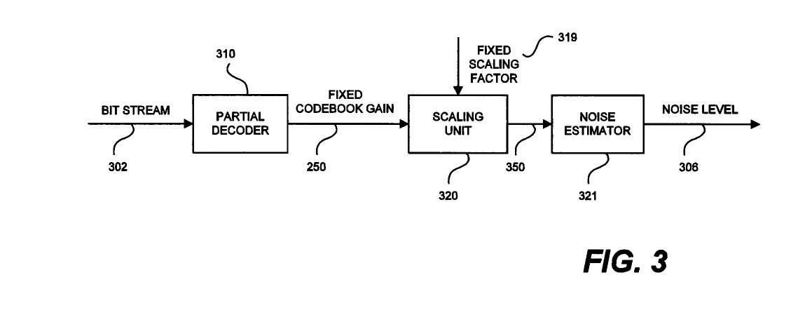

In view of the foregoing, FIG. 3 shows one illustrative embodiment of an arrangement for estimating noise in a speech signal according to the principles of the invention, which uses access point 271 in FIG. 2 as input for noise estimation. From bit stream 302, the fixed codebook gain 250 is decoded by partial decoder 310. For example, partial decoder 310 performs the task of unpacking the fixed codebook gain index, e.g., fixed codebook index 258 in FIG. 2, and retrieving the fixed codebook gain from a look up table via the fixed codebook gain index, i.e., the table index.

By partially decoding bit stream 302 according to the principles of the invention, the associated computational complexity of prior arrangements, which fully decode the bit stream to reconstruct the PCM signal, is avoided. By way of example, in previously filed U.S. patent application Ser. No. 10/449,288, which is incorporated by reference as if set forth fully herein, I recognized problems associated with prior voice quality enhancement techniques and developed an improved method based on direct processing of the bit stream in the network using a subset of decoded parameters from the speech signal. Accordingly, the teachings in U.S. patent application Ser. No. 10/449,288 set forth one exemplary arrangement that can be advantageously used in conjunction with the various illustrative embodiments of the present invention, e.g., for partially decoding bit stream 302 in decoder 310 (FIG. 3) to derive the desired excitation parameter.

Returning to the illustrative embodiment shown in FIG. 3, the fixed codebook gain 250 is subsequently scaled in scaling unit 320. The scaling unit simply multiplies the fixed codebook gain 250 with a fixed scaling factor 319 in order for the fixed codebook gain 250 to match its corresponding root mean square (RMS) signal level. In one illustrative embodiment, the scaling factor 319 is a constant set to a value of 0.3. The scaling factor 319 maps the excitation level to an RMS noise level that corresponds to the noise level of the original signal. It may also adjust for the skewness of the expected noise spectrum, as discussed previously. The scaled fixed codebook gain 350 is then provided as input to a noise estimator 321 of conventional design. Noise estimator 321 then estimates (in a conventional manner) the noise level 306 corresponding to the speech signal that is encoded in incoming bit stream 302. As one example of a noise estimator, see, e.g., commonly assigned U.S. patent application Ser. No. 09/107,919, “Estimating the Noise Components of a Signal”, filed Jun. 30, 1998, as well as the other aforementioned references, the contents of which are incorporated by reference herein. Accordingly, I have discovered that noise estimation can be performed according to the principles of the invention by using the scaled fixed codebook gain 350 (via scaling unit 320 and scaling factor 319) as input.

By way of further background, it is noted that a noise estimator that estimates the noise level from magnitude values, i.e., values that are always positive (such as the fixed codebook gain), does not need an absolute value computation (or rectifier) at its initial stage. In this respect, noise estimation from a fixed codebook gain sequence is similar to noise estimation from spectral magnitude values, but unlike noise estimation from a speech signal with negative and positive values where an absolute value computation needs to be present at the initial stage of the noise estimator.

In the illustrative embodiment shown in FIG. 3, the noise level estimate is provided in linear format. According to another illustrative embodiment, if the application that uses the noise estimator requires the noise estimate to be in logarithmic format (e.g., in dB), one can alternatively directly use the fixed codebook gain table index, without first retrieving the fixed codebook gain via the transmitted table index. This alternative approach is possible since the fixed codebook gain table follows a more or less logarithmic quantization. Using the fixed codebook table index directly further reduces the computational complexity by saving a table look-up. Other modifications will be apparent to one skilled in the art and are contemplated by the teachings herein.

FIG. 4 shows another illustrative embodiment of an arrangement for estimating noise in a speech signal according to the principles of the invention. The embodiment shown in FIG. 4 is similar to that shown in FIG. 3 except that an adaptive scaling unit 420 is used to adapt the scaling factor to the signal, whereas the embodiment shown in FIG. 3 uses a constant (fixed) scaling factor.

More specifically, partial decoder 410 receives bit stream 402 and extracts the fixed codebook gain 250 (as described previously in FIG. 3) and the adaptive codebook gain 252 in a similar manner (e.g., using a lookup table and adaptive codebook index 259 as described in FIG. 2). Scaling factor computation unit 430 uses the adaptive codebook gain 252 provided from partial decoder 410 to track the minimum of adaptive codebook gain 252. In noise-free speech, for example, the minimum of adaptive codebook gain 252 would be close to zero, while in speech with deterministic noise, the minimum increases accordingly. In this manner, the minimum of adaptive codebook gain 252 is used to adjust the scaling factor 431 in order to avoid underestimating the noise level in the signal.

In particular, scaling factor computation unit 430 would increase the scaling factor 431 whenever the minimum of adaptive codebook gain 252 increases and visa versa. In this manner, scaling factor computation unit 430 behaves similarly to a decoder itself, e.g., a large adaptive codebook gain 252 increases the output level of the excitation 254 (FIG. 2).

Scaling factor 431 is then used to adapt the fixed codebook gain 250 via adaptive scaling unit 420, the result then being provided as input to noise estimator 421 of conventional design. In a similar manner as previously described, noise estimator 421 then estimates the noise level 406 corresponding to the speech signal that is encoded in incoming bit stream 402.

Alternatively, or in addition, the adaptive codebook index 259 (FIG. 2) may be used and checked for stationarity. In speech, the adaptive codebook index is constantly changing, while most noise sources tend towards longer time intervals of stationarity.

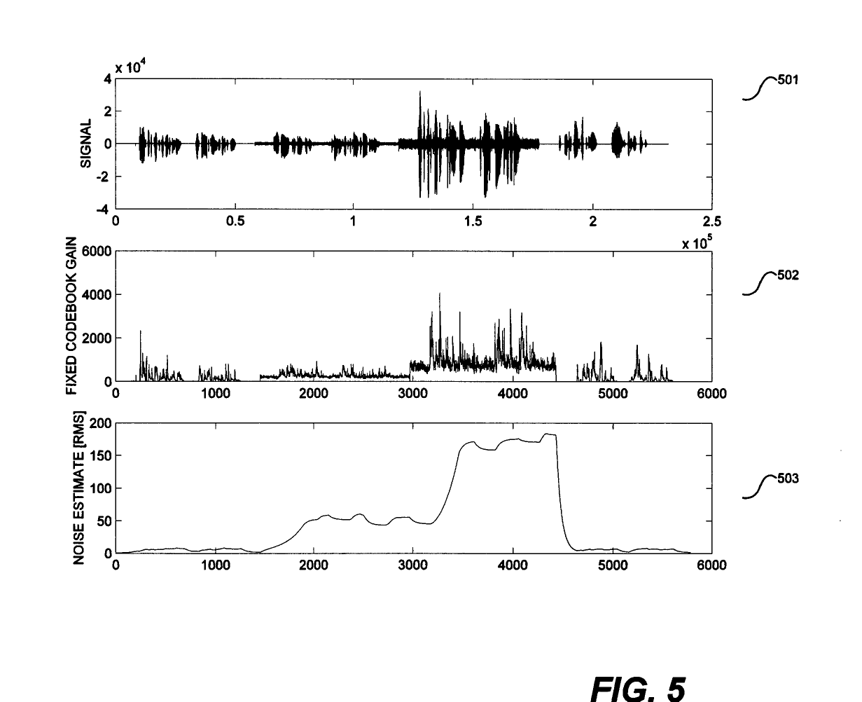

FIG. 5 shows an example for a sampled noisy speech signal and its resulting noise level estimate when noise estimation is performed according to the principles of the invention described for the embodiment shown in FIG. 3. Plot 501 shows the noisy speech signal. This signal was artificially created to show the adaptation of the bit stream noise estimator. In particular, starting from a noise-free speech signal, car noise at a level of −37 dBm was added to the noise-free speech signal at sample 58'000. Later, at sample 119'000, the level of the car noise was increased by 10 dB to a level of −27 dBm. At sample 177'500, the noise was stopped. The noisy speech signal obtained in this way was then encoded with an AMR speech encoder in the 12.2 kbits/s mode. Subsequent decoding resulted in a fixed codebook gain shown in plot 502. Finally, to compute the noise level estimate shown in plot 503, the noise estimator described in the aforementioned U.S. patent application Ser. No. 09/107,919, filed Jun. 30, 1998 by W. Etter, entitled “Estimating the Noise Components of a Signal”, was applied using the fixed codebook gain shown in plot 502 as input according to the principles of the invention. It should be noted that since the fixed codebook gain is determined once per 40-sample frame, the x-scales (abscissa) in plots 501 are different from the x-scales in plots 502 and 503. Plot 502 shows that the noise level increases the base level of the fixed codebook gain. In the noise estimate plot 503, one can identify the sections where the noise estimator adapts to an increase in noise level, e.g., these sections are from sample 1'500 to sample 2'000 and from sample 3'000 to sample 3'500. The adaptation to a decrease in noise level is typically shorter, e.g., in plot 503 the decrease occurs from sample 4'500 to sample 4'700. It is also noteworthy that the noise level estimate shows roughly an increase corresponding to 10 dB from sample 3'000 to 3'500, as expected form the noisy speech signal.

To illustrate one advantage of the embodiments shown and described herein, consider the channel densities that can be achieved as compared to the prior art arrangements. For example, conventional PCM-based noise estimation for a GSM AMR codec requires about 5 MIPS for a full decoder of each channel. By contrast, noise estimation according to the principles of the invention only requires a partial decoder on the order of approximately 0.1 MIPS (unpacking and table lookup only). Adding the complexity of the noise estimator, e.g., an estimated 0.5 MIPS in both noise estimation examples, it becomes apparent that a 100 MIPS processor, when only used for noise estimation, can therefore serve 165 channels (100 MIPS/0.6 MIPS) in the case of noise estimation according to the invention, whereas the same 100 MIPS processor can only serve 18 channels (100 MIPS/5.5 MIPS) in the case of conventional PCM-based noise estimation.

In general, the foregoing embodiments are merely illustrative of the principles of the invention. Those skilled in the art will be able to devise numerous arrangements and modifications, which, although not explicitly shown or described herein, nevertheless embody those principles that are within the scope of the invention. For example, the invention was described in the context of certain illustrative embodiments, such as the partial decoding operation in an AMR codec, but these embodiments are not intended be limiting in any way. It is contemplated that other modifications and arrangements will also be apparent to those skilled in the art in view of the teachings herein. For example, the principles of the invention can be applied in other coding arrangements (e.g., other than AMR-based decoders), in other wireless standards-based transmissions (e.g., other than GSM), and in Internet Protocol (IP)-based applications such as Voice over IP (Internet Protocol), and so on. Accordingly, the embodiments shown and described herein are only meant to be illustrative and not limiting in any manner.

Moreover, all statements herein reciting principles, aspects, and embodiments of the invention, as well as specific examples thereof, are intended to encompass both structural and functional equivalents thereof. Additionally, it is intended that such equivalents include both currently known equivalents as well as equivalents developed in the future, i.e., any elements developed that perform the same function, regardless of structure. Thus, for example, it will be appreciated by those skilled in the art that any block diagrams herein represent conceptual views of illustrative circuitry embodying the principles of the invention. Similarly, it will be appreciated that any flow charts, flow diagrams, state transition diagrams, pseudocode, and the like represent various processes which may be substantially represented in computer readable medium and so executed by a computer or processor, whether or not such computer or processor is explicitly shown.

The functions of the various elements shown in the figures, including any functional blocks labeled as “processors”, may be provided through the use of dedicated hardware as well as hardware capable of executing software in association with appropriate software. When provided by a processor, the functions may be provided by a single dedicated processor, by a single shared processor, or by a plurality of individual processors, some of which may be shared. Moreover, explicit use of the term “processor” or “controller” should not be construed to refer exclusively to hardware capable of executing software, and may implicitly include, without limitation, digital signal processor (DSP) hardware, network processor, application specific integrated circuit (ASIC), field programmable gate array (FPGA), read-only memory (ROM) for storing software, random access memory (RAM), and non-volatile storage. Other hardware, conventional and/or custom, may also be included. Similarly, any switches shown in the FIGS. are conceptual only. Their function may be carried out through the operation of program logic, through dedicated logic, through the interaction of program control and dedicated logic, or even manually, the particular technique being selectable by the implementer as more specifically understood from the context.

Software modules, or simply modules which are implied to be software, may be represented herein as any combination of flowchart elements or other elements indicating performance of process steps and/or textual description. Such modules may be executed by hardware that is expressly or implicitly shown.

In the claims hereof any element expressed as a means for performing a specified function is intended to encompass any way of performing that function including, for example, a) a combination of circuit elements which performs that function or b) software in any form, including, therefore, firmware, microcode or the like, combined with appropriate circuitry for executing that software to perform the function. The invention as defined by such claims resides in the fact that the functionalities provided by the various recited means are combined and brought together in the manner which the claims call for. Applicant thus regards any means which can provide those functionalities as equivalent as those shown herein. Finally, the scope of the invention is limited only by the claims appended hereto.

1. A method for processing a voice signal in a communications network, the method comprising:
partially decoding a bit stream corresponding to an encoded version of the voice signal to obtain an excitation parameter corresponding to the voice signal; and
estimating a noise level of the voice signal using the excitation parameter as input.

2. The method according to claim 1, wherein the excitation parameter comprises a fixed codebook excitation component.

3. The method according to claim 1, wherein the excitation parameter comprises a fixed codebook gain table index.

4. The method according to claim 1, wherein the excitation parameter comprises a fixed codebook gain parameter.

5. The method according to claim 4, further comprising the step of multiplying the fixed codebook gain parameter by a scaling factor.

6. The method according to claim 5, wherein the scaling factor is a constant value.

7. The method according to claim 6, wherein the constant value is approximately 0.3.

8. The method according to claim 1, wherein the excitation parameter comprises a fixed codebook gain component and an adaptive codebook gain component.

9. The method according to claim 8, further comprising the step of multiplying the fixed codebook gain component by a scaling factor.

10. The method according to claim 9, wherein the scaling factor is a variable scaling factor.

11. The method according to claim 10, further comprising the step of computing the variable scaling factor as a function of the adaptive codebook gain component.

12. A method for estimating noise in a speech signal in a communications network, wherein the speech signal is encoded and transported through the network as a bit stream, the method comprising:
partially decoding the bit stream to obtain a fixed codebook excitation component and an adaptive codebook excitation component corresponding to the encoded speech signal; and
estimating a noise level of the speech signal based on the fixed codebook excitation component and the adaptive codebook excitation component.

13. The method according to claim 12, further comprising the step of scaling the fixed codebook excitation component according to a constant value.

14. The method according to claim 12, further comprising the step of scaling the fixed codebook excitation component as a function of the adaptive codebook excitation component.

15. An apparatus for processing a speech signal, the apparatus comprising:
a decoder for extracting an excitation parameter from a bit stream corresponding to an encoded speech signal; and
a noise estimator operable to estimate a noise level in the speech signal using the excitation parameter as input.

16. The apparatus according to claim 15, wherein the excitation parameter comprises a parameter selected from the group consisting of a fixed codebook excitation component, a fixed codebook gain table index, and a fixed codebook gain parameter.

17. The apparatus according to claim 15, further comprising a multiplier element operable to multiply the excitation parameter by a scaling factor.

18. The apparatus according to claim 17, wherein the scaling factor is a constant value.

19. The apparatus according to claim 15, wherein the excitation parameter comprises a fixed codebook gain component and an adaptive codebook gain component.

20. The apparatus according to claim 19, further comprising a multiplier element operable to multiply the fixed codebook gain component by a scaling factor.

21. The apparatus according to claim 20, wherein the scaling factor is variable as a function of the adaptive codebook gain component.
